(19) United States
(12) Patent Application Publication
(10) Pub. No.: US 2019/0012168 A1
(43) Pub. Date: Jan. 10, 2019

(54) PROGRAM GENERATING APPARATUS

(71) Applicant: FANUC Corporation, Yamanashi (JP)

(72) Inventor: Shouhei MIYASHITA, Yamanashi (JP)

(21) Appl. No.: 16/026,595

(22) Filed: Jul. 3, 2018

(30) Foreign Application Priority Data
Jul. 4, 2017 (JP) 2017-131021

(51) Int. Cl. G06F 8/76; G06F 8/41; G06F 8/51

(52) U.S. Cl. CPC G06F 8/76; G06F 8/51; G06F 8/41

(57) ABSTRACT

A program generating apparatus capable of easily porting programs between programmable logic controllers of different models includes a source program input unit inputting a conversion origin source program and a source program conversion unit converting the conversion origin source program to a source program for a conversion destination model. The source program conversion unit converts the conversion origin source program into a source program for the conversion destination model on the basis of an instruction correspondence table retaining information on whether or not an instruction is usable for each model, an instruction conversion library retaining an alternative code of the instruction for each model, an address range table retaining information on whether or not an address range is usable for each model, and an address use table retaining information on whether or not an address is used for each model.

### BACKGROUND OF THE INVENTION

### 1. Field of the Invention

The present invention relates to a program generating apparatus, and particularly, to a program generating apparatus capable of easily porting programs between programmable logic controllers of different models.

### 2. Description of Related Art

In a factory, there exist a plurality of programmable logic controllers (including a programmable machine controller (PMC) or the like and, hereinafter, being referred to as a “PLC”) performing control on the basis of a ladder program or the like. The PLC operates by reading an object code generated for each model. The object code is generated by compiling a ladder program generated and edited for each model with, for example, a ladder editing tool. Hereinafter, a program such as a ladder program which is a source of the object code is simply referred to as a program or a source program.

In some cases, the source program may be ported between different models. This is because different manufacturers and models of PLCs may have different specifications of programming languages (for example, types of instructions, usable memory ranges, or the like). For example, the porting is performed in a case where a source program for controlling a peripheral device or a source program for realizing a specific function is desired to be executed in the same manner even for different models.

In the related art, Japanese Patent Laid-Open No. 2014-052673 A discloses porting of a source program between different models. Japanese Patent Laid-Open No. 2014-052673 A discloses a technique invalidating an instruction in a ladder program of a porting destination in a case where the instruction not corresponding to a PLC of the porting destination is included in the ladder program of a porting source.

However, if some instruction is invalidated as described in Japanese Patent Laid-Open No. 2014-052673 A, contents of the source program will differ between the porting source and the porting destination, so that the same operations cannot be realized between different models. In addition, since types and ranges of addresses that can be handled for different models of the PLCs are also different, the addresses as well as the instructions need to be corrected at the time of porting the source program. However, Japanese Patent Laid-Open No. 2014-052673 A does not mention any address correcting method.

### SUMMARY OF THE INVENTION

The invention has been conceived to solve such problems, and an object of the invention is to provide a program generating apparatus capable of easily porting programs between programmable logic controllers of different models.

According to an aspect of the invention, there is provided is a program generating apparatus converting a source program for a programmable logic controller between different models, including: a source program input unit inputting a conversion origin source program; and a source program conversion unit converting the conversion origin source program into a source program for a conversion destination model on the basis of an instruction correspondence table retaining information on whether or not an instruction is usable for each model of the programmable logic controller, an instruction conversion library retaining an alternative code of the instruction for each model of the programmable logic controller, an address range table retaining information on whether or not an address range is usable for each model of the programmable logic controller, and an address use table retaining information on whether or not an address is used for each model of the programmable logic controller.

In the program generating apparatus according to the above aspect of the invention, the source program conversion unit may determine whether or not an instruction unusable for the conversion destination model is included in the conversion origin source program with reference to the instruction correspondence table, convert the instruction unusable for the conversion destination model into an alternative code with reference to the instruction conversion library in a case where the instruction unusable for the conversion destination model is included in the conversion origin source program, determine whether or not an address unusable for the conversion destination model is included in the conversion origin source program with reference to the address range table, and convert the address unusable for the conversion destination model into an address usable and unused for the conversion destination model with reference to the address use table in a case where the address unusable for the conversion destination model is included in the conversion origin source program.

The program generating apparatus according to the above aspect of the invention may further include a compiler converting the source program for the conversion destination model converted from the conversion origin source program into an object code for the conversion destination model.

In the program generating apparatus according to the above aspect of the invention, the source program conversion unit may convert only a portion of the conversion origin source program into the source program for the conversion destination model and combine the source program with a source program for the existing conversion destination model.

According to the invention, it is possible to provide a program generating apparatus capable of easily porting programs between programmable logic controllers of different models.

### BRIEF DESCRIPTION OF THE DRAWINGS

The foregoing and other objects and features of the invention will become apparent from the following description of embodiments with reference to the accompanying drawings:

FIG. 1 is a block diagram illustrating a configuration of a program generating apparatus;

FIG. 2 is a diagram illustrating an outline of operations of a compiler;

FIG. 3 is a diagram illustrating an outline of operations of a source program conversion unit;

FIG. 4 is a diagram illustrating an outline of operations of the source program conversion unit;

FIG. 5 is a flowchart illustrating operations of the program generating apparatus;

FIG. 6 is a flowchart illustrating the operation of the source program conversion unit;

FIG. 7 is a flowchart illustrating the operation of the source program conversion unit;

FIG. 8 is a diagram illustrating an example of an instruction correspondence table;

FIG. 9 is a block diagram illustrating an example of an instruction conversion library;

FIG. 10 is a block diagram illustrating an example of an address range table;

FIG. 11 is a block diagram illustrating an example of an address use table;

FIG. 12 is a diagram describing an embodiment of a program generating apparatus;

FIG. 13 is a diagram describing an embodiment of the program generating apparatus;

FIG. 14 is a diagram describing an embodiment of the program generating apparatus; and

FIG. 15 is a diagram illustrating an example of an alternative code.

### DETAILED DESCRIPTION OF THE PREFERRED EMBODIMENTS

Embodiments of the invention will be described with reference to the drawings.

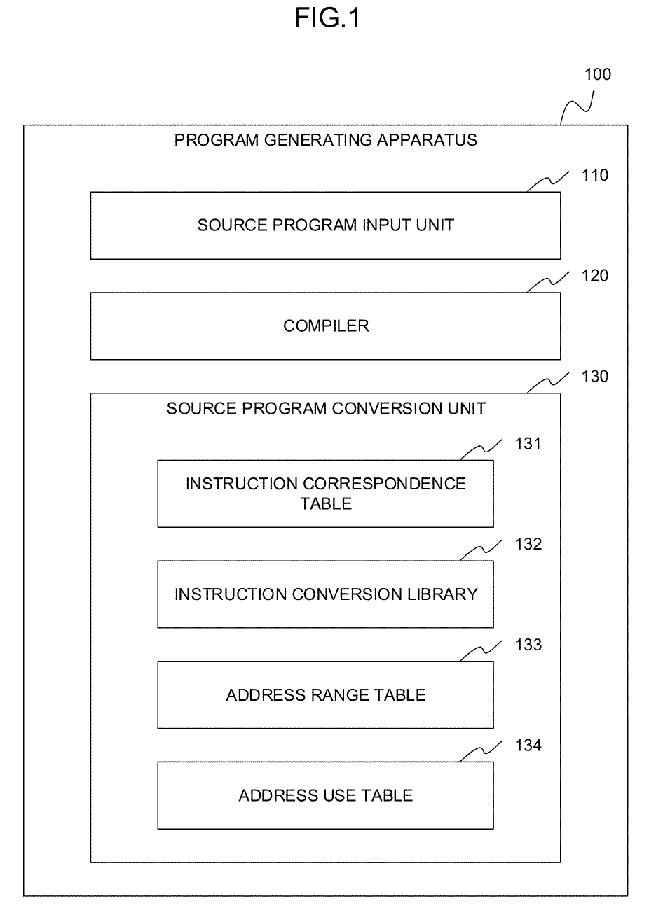

FIG. 1 is a block diagram illustrating a functional configuration of the program generating apparatus 100. The program generating apparatus 100 is typically a computer having a central processing unit (CPU), a storage device, an input/output device, and the like. The CPU reads out and executes the program stored in the storage device, so that predetermined functions (for example, respective processing units described later) are logically realized. The program generating apparatus 100 may be configured with a single computer or may be configured with a plurality of computers. The program generating apparatus 100 may be a general-purpose computer or a dedicated computer such as a numerical controller. The program generating apparatus 100 includes a source program input unit 110, a compiler 120, and a source program conversion unit 130 as processing units.

The source program input unit 110 performs a process of inputting a source program for a PLC of a specific model. For example, the source program input unit 110 saves an editor or a source program input from an outside in a predetermined storage area.

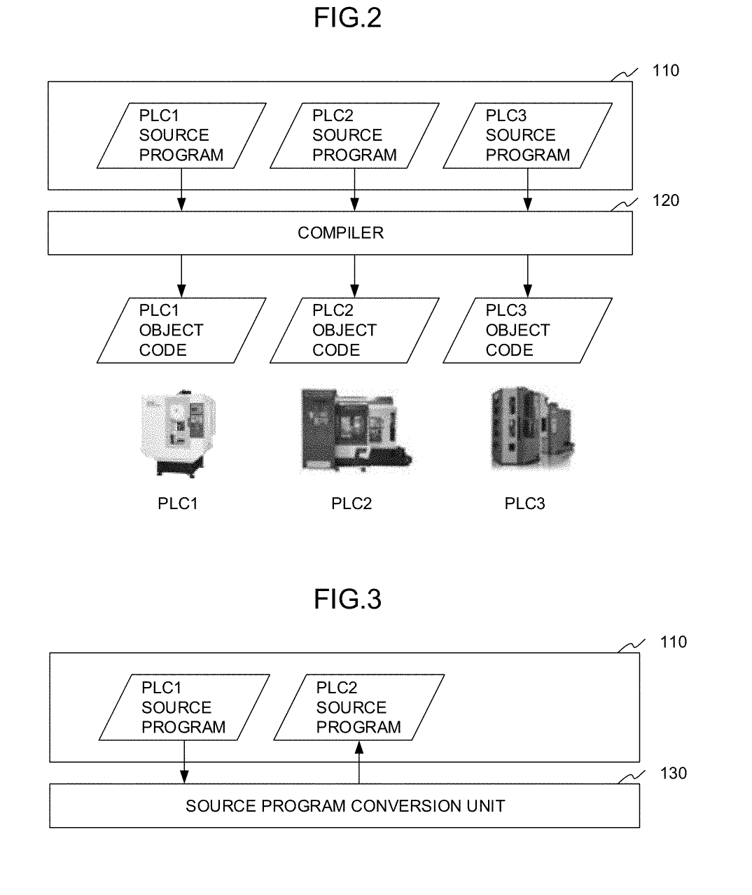

The compiler 120 performs a process of converting the source program into an object code. As illustrated in FIG. 2, the compiler 120 reads a source program generated for each model (for example, PLC 1, PLC 2, and PLC 3) from the source program input unit 110. The compiler 120 retains a conversion rule between a source program and an object code for each model, converts a source program for a certain model (for example, PLC 1) into an object code for the same model (PLC 1), and outputs the object code. The output object code for each model is used for each corresponding PLC model in a factory.

The source program conversion unit 130 performs a process of converting a source program for a certain model into a source program for a different model. For example, as illustrated in FIG. 3, the source program conversion unit 130 reads a source program generated for a specific model (for example, PLC 1) from the source program input unit 110. The source program conversion unit 130 retains a conversion rule for source programs of different models, and converts a source program for a certain model (PLC 1) into a source program for a different model (for example, PLC 2). The converted source program (for PLC 2) is output to, for example, the source program input unit 110.

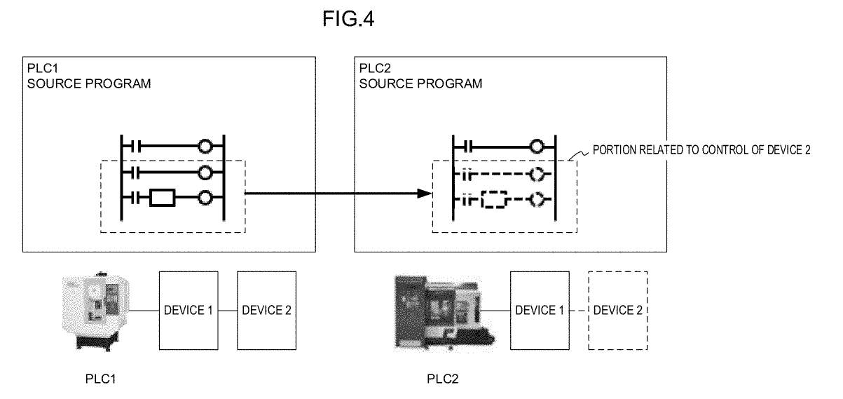

The source program conversion unit 130 may convert the entire source program or may convert only a portion of the source program. For example, as illustrated in FIG. 4, in a case where it is desired to newly connect a device 2 connected to the PLC 1 to the PLC 2, only a portion related to the control of the device 2 in the source program of the PLC 1 may be converted for the PLC 2. At this time, the source program conversion unit 130 may read only the portion of the source program to be converted from the source program input unit 110, and an interface for specifying the portion to be converted in the source program read from the source program input unit 110 may be provided.

As illustrated in FIG. 1, the source program conversion unit 130 includes an instruction correspondence table 131, an instruction conversion library 132, an address range table 133, and an address use table 134. The instruction correspondence table 131 retains instructions usable for each model of a PLC. The instruction conversion library 132 retains instructions and alternative codes (for example, a ladder circuit) having functions equivalent to the instructions. The address range table 133 retains an address range usable for each model of the PLC. The address use table 134 retains an address being used for each model of the PLC.

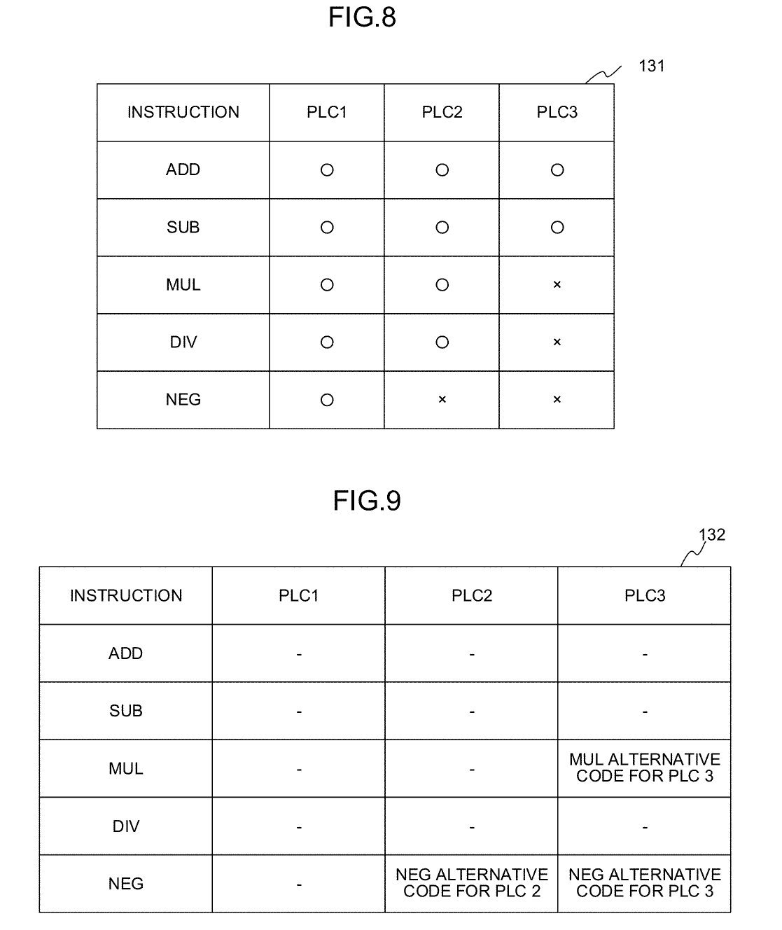

The source program conversion unit 130 checks whether the conversion destination model corresponds to an instruction used in the conversion origin source program (that is, whether an instruction is usable for the conversion destination model) with reference to the instruction correspondence table 131. FIG. 8 illustrates an example of the instruction correspondence table 131. The instruction correspondence table 131 retains correspondence statuses of instructions (ADD, SUB, MUL, . . . ) in a plurality of models (PLC 1, PLC 2, and PLC 3). “0” indicates that an instruction is usable for a model, and “x” indicates that an instruction is unusable. The instruction correspondence table 131 indicates that the model PLC 1 corresponds to all instructions, the model PLC 2 corresponds to instructions excluding an instruction NEG, and the model PLC 3 corresponds to instructions excluding instructions MUL, DIV, and NEG.

In a case where the conversion destination model does not correspond to the instruction used in the conversion origin source program, the source program conversion unit 130 checks whether there exists an alternative code having a function equivalent to the instruction with reference to the instruction conversion library 132. In a case where there exists the alternative code, the source program is converted by replacing the instruction with the alternative code. FIG. 9 illustrates an example of the instruction conversion library 132. The instruction conversion library 132 retains the alternative codes of the instructions (MUL, DIV, and NEG) in a plurality of the models (PLC 1, PLC 2, and PLC 3). For example, if the source program is a ladder program, the alternative code is a module of a ladder circuit. The instruction conversion library 132 retains an alternative code of the instruction NEG for the model PLC 2 and alternative codes of the instructions MUL and NEG for the model PLC 3. In addition, the instruction conversion library 132 does not retain an alternative code of the instruction DIV for the model PLC 3. In a case where, in the conversion origin source program, the instruction DIV is used, the model PLC 3 does not correspond to the instruction DIV, and there does not exist an alternative code of the instruction DIV for the model PLC 3, the source program conversion unit 130 cannot convert the source program.

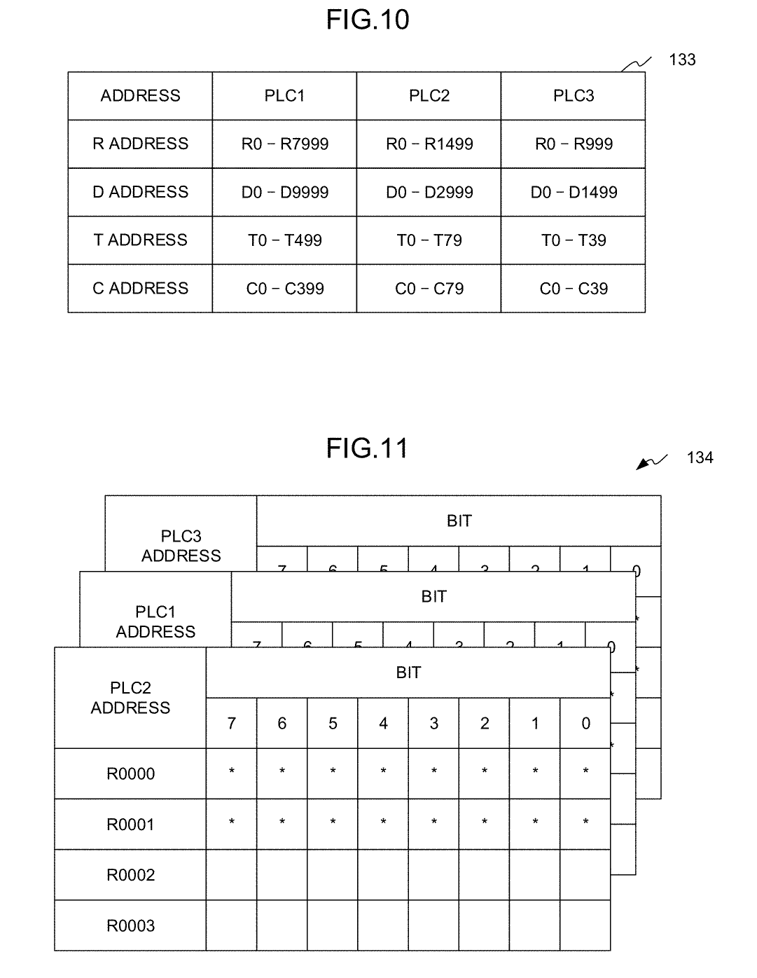

The source program conversion unit 130 checks whether the address used in the conversion origin source program is usable for the conversion destination model with reference to the address range table 133. FIG. 10 illustrates an example of the address range table 133. The address range table 133 retains address ranges usable for a plurality of the models (PLC 1, PLC 2, and PLC 3). The address range table 133 indicates that a range from R0 to R7999 as an R address, D0 to D9999 as a D address, T0 to T499 as a T address, and C0 to C399 as a C address are usable for the model PLC 1. Similarly, the address range table 133 also indicates address ranges usable for the models PLC 2 and PLC 3.

In a case where the address used in the conversion origin source program is unusable for the conversion destination model, the source program conversion unit 130 checks whether or not there exists an address unused for the conversion destination model with reference to the address use table 134. In a case where there exists the unused address, the source program conversion unit 130 converts the source program by replacing the address used in the conversion origin source program with the unused address. FIG. 11 illustrates an example of the address use table 134. The address use table 134 retains the use state of addresses in the model PLC 2. “*” Indicates that the storage area has already been used, and blanks indicate that the storage area is unused. The address use table 134 indicates that R0000 and R0001 have already been used for the model PLC 2 and that the address R0002.0 and the subsequent addresses are unused.

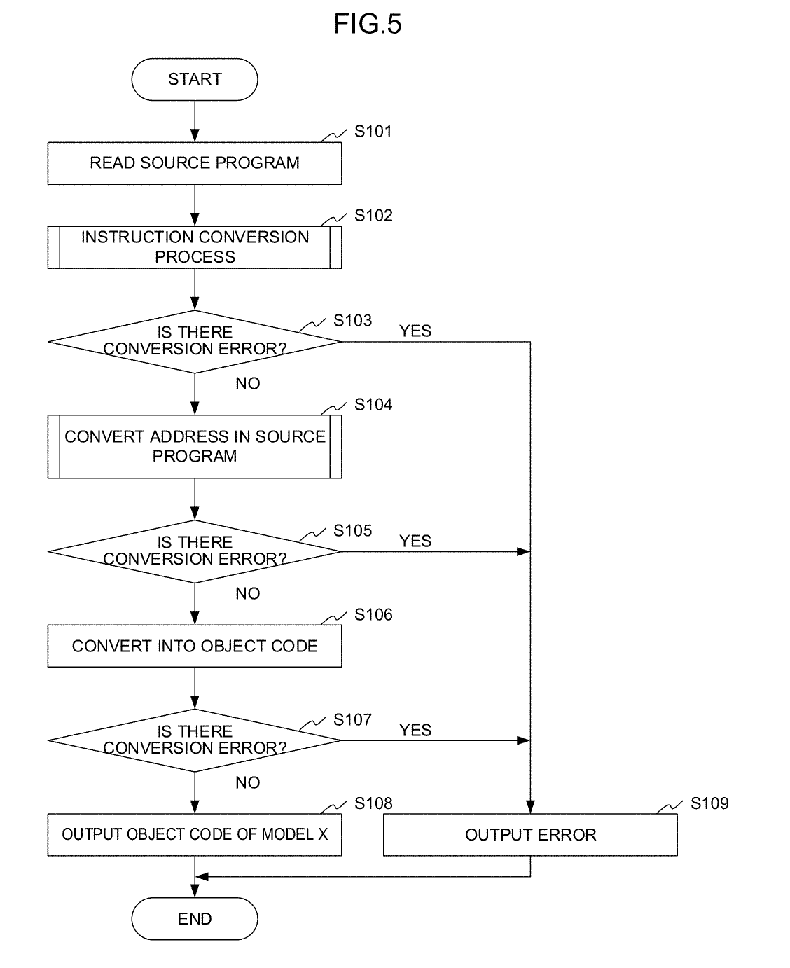

An example of the operations of the program generating apparatus 100 will be described with reference to the flowchart of FIG. 5.

In this example, the program generating apparatus 100 reads a certain source program, converts the source program into a source program for a model X, and converts the converted source program into an object code for the model X.

S101: The source program conversion unit 130 reads the source program from the source program input unit 110. This source program is a source program which is a conversion source.

S102: The source program conversion unit 130 analyzes the read instruction of the source program and converts the instruction into an instruction usable for the model X of the conversion destination if necessary (instruction conversion process). The contents of the instruction conversion process will be described later.

S103: In a case where an error occurs during the instruction conversion process, the error is output (S109).

S104: The source program conversion unit 130 analyzes the address used in the read source program and converts the address into an address that is usable for the model X of the conversion destination if necessary (address conversion process). The contents of the address conversion process will be described later.

S105: In a case where an error occurs during address conversion process, the error is output (S109).

S106: The source program conversion unit 130 outputs the source program subjected to the instruction conversion process and the address conversion process as a source program for the model X. The source program conversion unit 130 outputs the source program for the model X to the source program input unit 110. Alternatively, the source program for the model X may be delivered directly to the compiler 120.

In addition, it is preferable that the source program conversion unit 130 also copies symbols (aliases attached to the addresses), comments, and the like of the addresses included in the source program of the conversion origin to the source program for the model X. This is because the readability of the source program is maintained.

The compiler 120 acquires the source program for the model X and converts the source program for the model X into the object code for the model X in accordance with the conversion rule retained beforehand.

S107: In a case where an error occurs during the compiling, the error is output (S109).

S108: The compiler 120 outputs the object code for the model X.

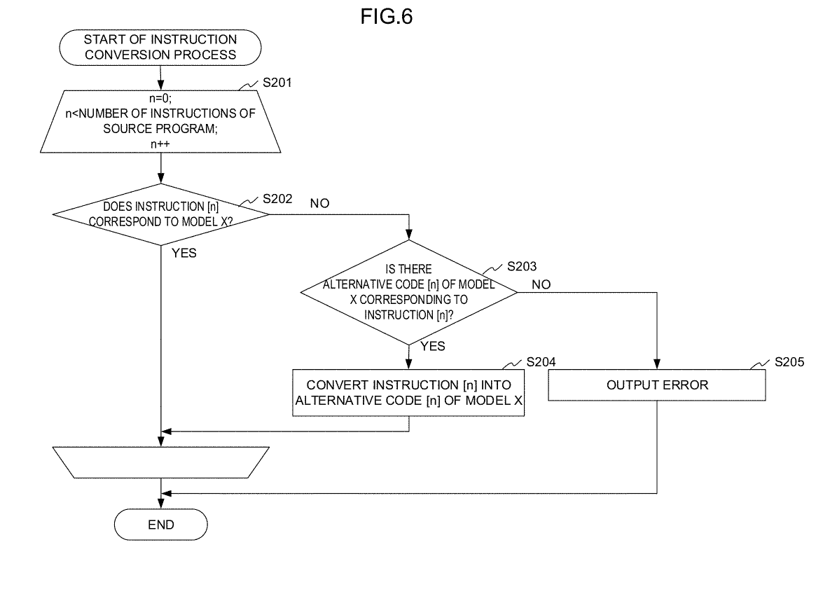

The instruction conversion process will be specifically described with reference to the flowchart of FIG. 6.

S201: The source program conversion unit 130 executes the processes in S202 and subsequent steps for all the instructions included in the source program of the conversion origin.

S202: The source program conversion unit 130 checks whether the model X corresponds to the instruction used in the conversion origin source program with reference to the instruction correspondence table 131. In a case where the model X does not correspond to the instruction, the process proceeds to S203.

S203: The source program conversion unit 130 checks whether there exists an alternative code for the model X having a function equivalent to the instruction with reference to the instruction conversion library 132. In a case where there exists the alternative code, the process proceeds to S204. In a case where there does not exist the alternative code, the process proceeds to S205.

S204: The source program conversion unit 130 replaces the instruction included in the conversion origin source program with the alternative code.

S205: Since this source program cannot be converted into a source program for the model X, the source program conversion unit 130 outputs an error.

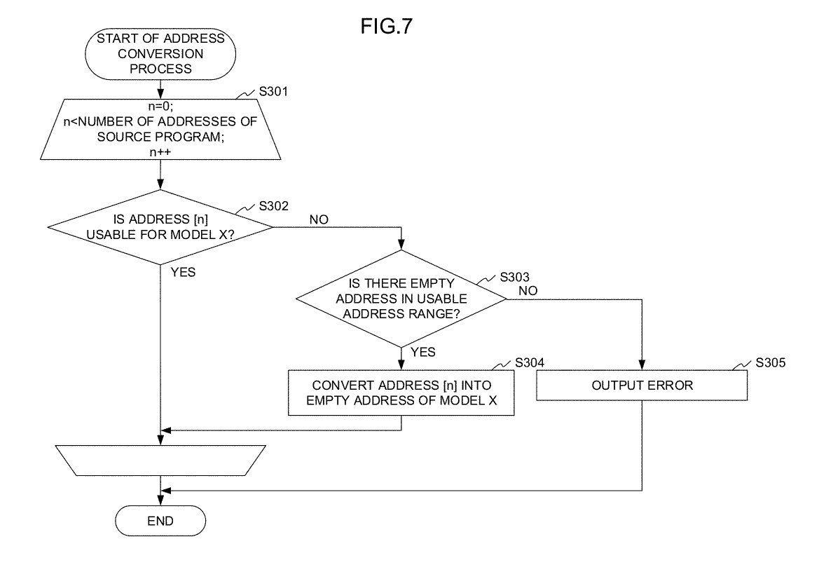

The address conversion process will be specifically described with reference to the flowchart of FIG. 7.

S301: The source program conversion unit 130 executes the processes in S302 and subsequent steps for all the addresses used in the source program of the conversion origin.

S302: The source program conversion unit 130 checks whether or not the address used in the conversion origin source program is usable for the model X with reference to the address range table 133. In a case where the address is unusable, the process proceeds to S303.

S303: The source program conversion unit 130 checks whether or not there exists an address unused for the model X with reference to the address use table 134. In a case where there exists the unused address, the process proceeds to S304. In a case where there does not exist the unused address, the process proceeds to S305.

S304: The source program conversion unit 130 replaces the address used in the conversion origin source program with the unused address.

S305: Since this source program cannot be converted into a source program for the model X, the source program conversion unit 130 outputs an error.

According to this embodiment, in a case where the instruction included in the source program is unusable for the model of the porting destination, the source program conversion unit 130 replaces the instruction with an alternative code operating in the model of the porting destination. In addition, in a case where the address used by the source program is unusable for the model of the porting destination, the source program conversion unit 130 replaces the instruction with an unused address usable for the model of the porting destination. Therefore, it is possible to easily port the source program while achieving the same operations between different models.

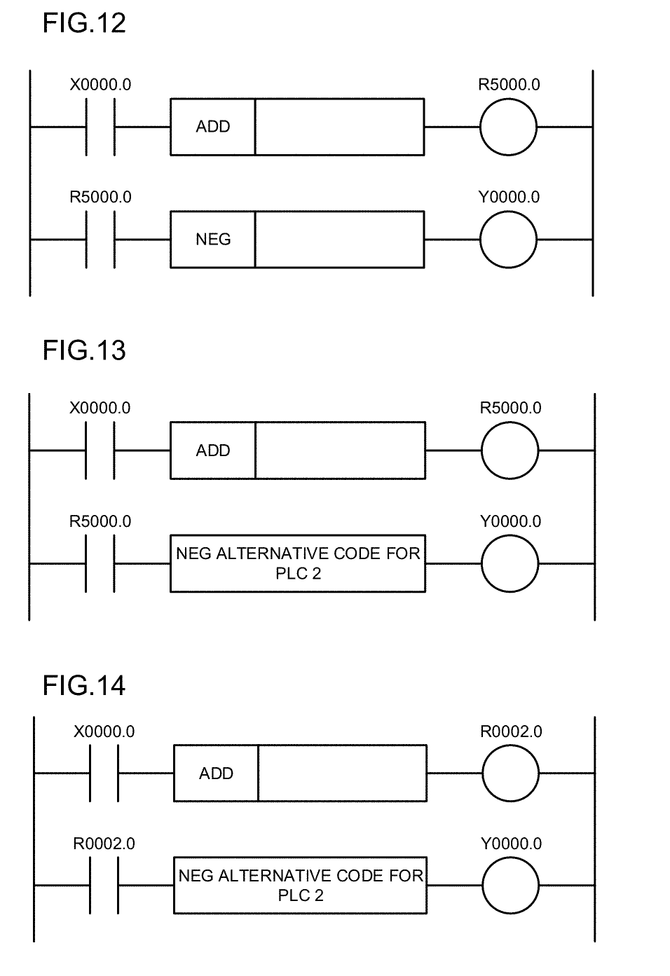

Subsequently, as an embodiment, the operations of the program generating apparatus 100 during converting the ladder program for the model PLC 1 into the ladder program for the model PLC 2 will be described. FIG. 12 illustrates a ladder program for the model PLC 1 as the conversion origin. This is, for example, a control program of an external device connected to the model PLC 1. ADD and NEG are instructions. X0000.0, R5000.0, and Y0000.0 are addresses that are to be used. The source program conversion unit 130 according to this embodiment includes an instruction correspondence table 131 illustrated in FIG. 8, an instruction conversion library 132 illustrated in FIG. 9, an address range table 133 illustrated in FIG. 10, and an address use table 134 illustrated in FIG. 11.

The source program conversion unit 130 checks whether the model PLC 2 corresponds to the instruction (ADD or NEG) used in the conversion origin ladder program with reference to the instruction correspondence table 131 of FIG. 8. According to the instruction correspondence table 131, the model PLC 2 does not correspond to the instruction NEG.

The source program conversion unit 130 checks whether there exists an alternative code for the model PLC 2 having a function equivalent to the instruction NEG with reference to the instruction conversion library 132 of FIG. 9. In the instruction conversion library 132, an NEG alternative code for the PLC 2 (NEG alternative ladder circuit for the PLC 2) is registered.

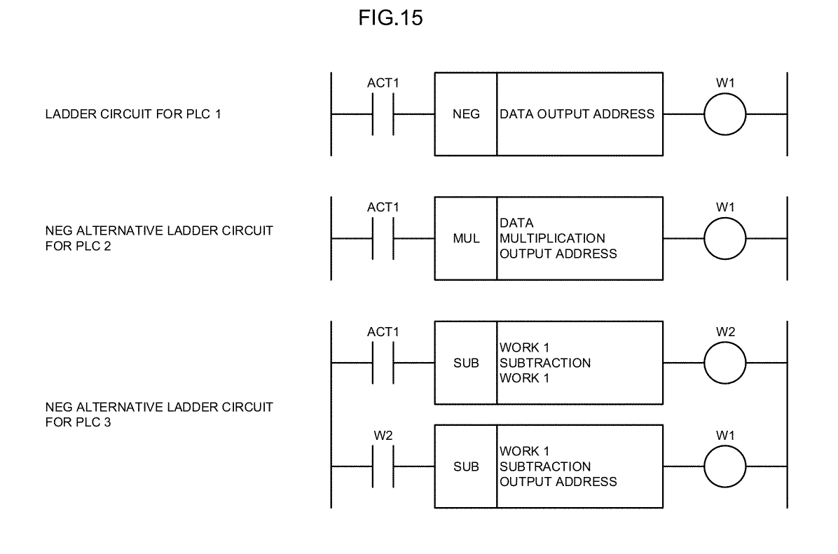

As a reference, FIG. 15 illustrates a specific example of the alternative code. The instruction NEG is an instruction for performing a sign inversion process. In the model PLC 1 corresponding to the instruction NEG, the instruction NEG can be realized by a ladder circuit illustrated in the upper diagram of FIG. 15. In the model PLC 2 not corresponding to the instruction NEG, the function equivalent to the instruction NEG can be realized by an alternative ladder circuit illustrated in the middle diagram of FIG. 15. The alternative ladder circuit performs the sign inversion process by using an instruction MUL corresponding to the model PLC 2. In the model PLC 3 not corresponding to the instruction NEG, the function equivalent to the instruction NEG can be realized by an alternative ladder circuit illustrated in the lower diagram of FIG. 15. Since the model PLC 3 does also not correspond to the instruction MUL, the sign inversion process is performed by using an instruction SUB corresponding to the model PLC 3. In this manner, the alternative codes are generated by using instructions corresponding to each model.

The source program conversion unit 130 replaces the instruction NEG of the ladder program for the model PLC 1 of the conversion origin with the NEG alternative code for the model PLC 2. FIG. 13 illustrates a ladder program that is subjected to the instruction conversion process.

The source program conversion unit 130 checks whether an address used in the conversion origin source program (in this embodiment, for simplicity of description, only R5000.0 is focused on) is usable for the model PLC 2 with reference to the address range table 133 of FIG. 10. According to the address range table 133, the address range usable for the model PLC 2 is from R0 to R1499, and R5000.0 is unusable.

The source program conversion unit 130 checks whether or not there exists an address unused for the model PLC 2 with reference to the address use table 134 of FIG. 11. According to the address use table 134, the address R0002.0 and the subsequent addresses are unused.

The source program conversion unit 130 replaces the address R5000.0 used in the conversion origin source program with the unused address R0002.0. FIG. 14 illustrates a ladder program that is subjected to the address conversion process.

The source program conversion unit 130 outputs the ladder program illustrated in FIG. 14 as a ladder program for the model PLC 2. The compiler 120 compiles the ladder program for the model PLC 2 and generates and outputs an object code for the model PLC 2. This object code is loaded on the model PLC 2, so that the same external device as the model PLC 1 is also usable for the model PLC 2.

Heretofore, although the embodiments of the invention have been described, the invention can be implemented in various modes by making appropriate changes without being limited only to the examples of the embodiments described above.

For example, although the ladder program is exemplified as the source program in the embodiments described above, the invention is not limited thereto, but for example, a program generated in an arbitrary language such as a function block diagram (FBD), a sequential function chart (SFC), an instruction list (IL), a structured text (ST) may be used as the source program. Similarly, a module generated in an arbitrary language may be used as an alternative code.

In addition, in the above-described embodiment, the example where the instruction conversion library 132 retains the alternative codes in advance has been described. The alternative codes of the instruction conversion library 132 may be editable as appropriate by a user. For example, the program generating apparatus 100 may include an interface for registering the alternative code generated by the user in the instruction conversion library 132 or editing the registered alternative code.

In addition, in the above-described embodiment, the instruction correspondence table 131 retains the instructions usable for each model of the PLC. However, the instruction correspondence table 131 may retain information on whether or not the instructions are usable and may retain, for example, unusable instructions. In addition, the address range table 133 retains the address range usable for each model of the PLC. However, the address range table 133 may retain information on whether or not addresses are usable and may retain, for example, unusable addresses. In addition, the address use table 134 retains the address being used for each model of the PLC. However, the address use table 134 may retain information on whether or not the address is used, and may retain, for example, unused addresses.

In addition, in the above-described embodiment, the example where the program generating apparatus 100 executes both the instruction conversion process and the address conversion process is described. However, the invention is not limited thereto, but only at least one of the instruction conversion process and the address conversion process may be executed.

1. A program generating apparatus converting a source program for a programmable logic controller between different models, comprising:
a source program input unit inputting a conversion origin source program; and
a source program conversion unit converting the conversion origin source program into a source program for a conversion destination model on the basis of an instruction correspondence table retaining information on whether or not an instruction is usable for each model of the programmable logic controller, an instruction conversion library retaining an alternative code of the instruction for each model of the programmable logic controller, an address range table retaining information on whether or not an address range is usable for each model of the programmable logic controller, and an address use table retaining information on whether or not an address is used for each model of the programmable logic controller.

2. The program generating apparatus according to claim 1, wherein the source program conversion unit:
determines whether or not an instruction unusable for the conversion destination model is included in the conversion origin source program with reference to the instruction correspondence table;
converts the instruction unusable for the conversion destination model into an alternative code with reference to the instruction conversion library in a case where the instruction unusable for the conversion destination model is included in the conversion origin source program;
determines whether or not an address unusable for the conversion destination model is included in the conversion origin source program with reference to the address range table; and
converts the address unusable for the conversion destination model into an address usable and unused for the conversion destination model with reference to the address use table in a case where the address unusable for the conversion destination model is included in the conversion origin source program.

3. The program generating apparatus according to claim 1, further comprising a compiler converting the source program for the conversion destination model converted from the conversion origin source program to an object code for the conversion destination model.

4. The program generating apparatus according to claim 1, wherein the source program conversion unit converts only a portion of the conversion origin source program into the source program for the conversion destination model and combines the source program with a source program for the existing conversion destination model.
